(19) United States
(12) Patent Application Publication
(10) Pub. No.: US 2007/0150641 A1
(43) Pub. Date: Jun. 28, 2007

(54) Bus Address Selecting Circuit and Bus Address Selecting Method

(75) Inventors: Iwao Honda, Ora-gun (JP); Hideki Ohashi, Kyoto-shi (JP); Takashi Kuroda, Ora-gun (JP); Noriyuki Tomita, Ota-shi (JP)

Correspondence Address: SoCAL IP LAW GROUP LLP, 310 N. WESTLAKE BLVD. STE 120, WESTLAKE VILLAGE, CA, 91362, US

(73) Assignee: SANYO ELECTRIC CO., LTD., Osaka (JP)

(21) Appl. No.: 11/614,807

(22) Filed: Dec. 21, 2006

(30) Foreign Application Priority Data
Dec. 22, 2005 (JP) 2005-369849

(51) Int. Cl. G06F 12/06

(52) U.S. Cl. 711/5

(57) ABSTRACT

A bus address selecting circuit is disclosed that selects addresses to be output to a first address bus connected to a first memory and a second address bus connected to a second memory, the bus address selecting circuit comprising an address output circuit that, based on a selecting bit composed of a predetermined plurality of bits in an instruction code, outputs addresses stored in first and second address registers out of a plurality of address registers as first and second addresses; and a bus selecting circuit that, based on predetermined higher-order n bits of at least one of the first and second addresses, outputs the first address to one of the first and second address buses and the second address to the other of the first and second address buses.

### BACKGROUND OF THE INVENTION

1. Field of the Invention

The present invention relates to a bus address selecting circuit and a bus address selecting method.

2. Description of Related Art

Some of processing circuits such as a Digital Signal Processor (DSP) incorporate a plurality of memories to execute data processing at high speed (see, e.g., “Sanyo Semiconductor News (No. N7458)”, Sanyo Electric Co., Ltd., <URL:http:H/service.semic.sanyo.co.jp/semi/ds_j/N7458.pdf>). FIG. 7 depicts an example of general configuration of a DSP having two memories (Static Random Access Memories: SRAMs). The DSP 100 comprises a DSP core 110 for executing data processing and SRAMs 121 and 122 for storing various kinds of data. The SRAM 121 is connected to an address bus A 131 and SRAM 122 is connected to an address bus B 141.

The DSP core 110 comprises an instruction register 151, a decoder 152, a control circuit 153, a plurality of address registers 154, and a selector 155. The instruction register 151 stores an instruction code read out from a Read Only Memory (ROM) not shown, etc. FIG. 8 depicts a general example of the instruction code. The instruction code 200 contains an instruction bit 210 indicating the kind of instruction and an address register selecting bit 211 for selecting two address registers included in the address registers 154.

The decoder 152 analyzes the instruction code 200 and notifies the control circuit 153 of such information as the kind of instruction and the address registers to be selected. The control circuit 153, based on the information notified by the decoder 152, transmits the information for selecting the address registers to the selector 155. The selector 155, based on the information from the control circuit 153, selects two address registers out of the address registers 154 and outputs the address stored in one address register to the address bus A 131 and the address stored in the other address register to the address bus B 141. Thereafter, reading or writing processing is executed to the specified addresses of the SRAMs 121 and 122.

FIG. 9 depicts an example of relationship between the address register selecting bit 211 and combinations of address registers. In this example the address register selecting bit 211 is of three bits, which can express eight kinds of combinations. Generally, the address register used together with an address register is, in many cases, fixed to one, such as an address register E together with an address register A, and an address register F together with an address register B. The addresses output to the address buses 131 and 141 are, in many cases, selected based on the order of description of the address registers in a program.

Specific description will be made with respect to the case of the program having the description of, for example, “r0h=[aa++], r0l=[ae++];”. This program shows that the data indicated by the address aa stored in the address register A is read out to a data register r0h (not shown) and the data indicated by the address ae stored in the address register E is read out to a data register r0l (not shown). At this moment, for example, the address aa described at the left side is output to the address bus A 131 and the address ae described at the right side is output to the address bus B 141. Namely, the address register selecting bit 211 in the instruction code 200 for executing this program is “000”.

In the case of the program having the description of, for example, “r0h=[ae++], r0l=[aa++];”, the address register selecting bit 211 is “100” and the address ae described at the left side is output to the address bus A 131 and the address aa described at the right side is output to the address bus B 141.

In the example shown in FIG. 9, the address register (e.g., address register E) that can be used as a pair to an address register (for example, address register A) is limited to one. In this connection, consideration is given to the case of executing the processing shown in FIG. 10. Data A1 stored in the SRAM 121 and data B1 stored in the SRAM 122 are used in the processing (1). Data A2 stored in the SRAM 121 and the above data B1 are used in the processing (2).

The procedure of executing the processing (1) and (2) in parallel is, for example, as follows. Firstly, the address of the data A1 is stored in the address register A and the address of the data B1 is stored in the address register E. Thereafter, the data A1 and the data B1 are read out for the execution of the processing (1). Then, in parallel with the procedure of executing the processing (1), the address of the data A2 is stored in the address register B and the address of the data B1 is stored in the address register F. Thereafter, the data A2 and the data B1 are read out for the execution of the processing (2).

In the case of the processing shown in FIG. 10, although the data B1 used in the processing (1) and the data B1 used in the processing (2) are the same, it is necessary to store the address of the data B1 in the address register F, and such extra storage causes the number of cycles to increase accordingly. Therefore, it is conceivable to so arrange that the address register E can be used in the processing (2) as well by increasing the combinations of the address registers shown in FIG. 9, but an increase in the number of combinations means an increase in the number of bits for the address register selecting bit 211 and an increase in the number of bits for the instruction code 200.

Also, since the addresses output to the address bus A 131 and the address bus B 141 are selected based on the order of description of the address registers in a program as described above, the flexibility in describing the program is low. While it is conceivable for the program to specify to which of the address buses 131 and 141 the output should be made, a code to indicate such specification will be required and the number of bits for the instruction code 200 will increase.

### SUMMARY OF THE INVENTION

The present invention was conceived in view of the above problems and it is therefore the object of the present invention to improve flexibility of selecting address buses without increasing the number of bits of the instruction code.

In order to achieve the above object, according to an aspect of the present invention there is provided a bus address selecting circuit that selects addresses to be output to a first address bus connected to a first memory and a second address bus connected to a second memory, comprising an address output circuit that, based on a selecting bit composed of a predetermined plurality of bits in an instruction code, outputs addresses stored in first and second address registers out of a plurality of address registers as first and second addresses; and a bus selecting circuit that, based on predetermined higher-order n bits of at least one of the first and second addresses, outputs the first address to one of the first and second address buses and the second address to the other of the first and second address buses.

The address output circuit may output the addresses stored in the first and second address registers out of the plurality of address registers as the first and second addresses when the selecting bit is of a first value and may output the addresses stored in a third address register and the second address register out of the plurality of address registers as the first and second addresses when the selecting bit is of a second value.

The address output circuit may comprise a selecting signal output circuit that, based on the selecting bit, outputs a selecting signal for selecting the first and second addresses; and a first selecting circuit that, based on the selecting signal, selects and outputs the first and second addresses out of the addresses stored in the plurality of address registers.

The bus selecting circuit may comprise a start address memory circuit that memorizes higher-order n bits of a start address of the second memory whose address in the address space is greater than that of the first memory, and the bus selecting circuit, based on the higher-order n bits of the start address memorized in the start address memory circuit and the higher-order n bits of at least one of the first and second addresses, may output the address smaller than the start address out of the first and second addresses to the first address bus and the other address out of the first and second addresses to the second address bus.

The higher-order n bits of the start address memorized in the start address memory circuit may be rewritable.

The bus selecting circuit may comprise the start address memory circuit; a comparison circuit that outputs the result of comparison of the higher-order n bits of the start address memorized in the start address memory circuit with the higher-order n bits of the first address; and a second selecting circuit that, based on the result of comparison output from the comparison circuit, outputs the address smaller than the start address out of the first and second addresses to the first address bus and the other address out of the first and second addresses to the second address bus.

The bus selecting circuit may comprise a start address memory circuit that memorizes higher-order n bits of first and second start addresses that are start addresses of the first and second memories, respectively, in the address space, and the bus selecting circuit, based on the higher-order n bits of the first and second start addresses memorized in the start address memory circuit and the higher-order n bits of the first address, may output the address that is equal to or greater than the first start address and smaller than the second start address out of the first and second addresses to the first address bus and the other address out of the first and second addresses to the second address bus.

The higher-order n bits of the first and second start addresses memorized in the start address memory circuit may be rewritable.

The bus selecting circuit may comprise the start address memory circuit; a first comparison circuit that outputs the result of comparison of the higher-order n bits of the first start address memorized in the start address memory circuit with the higher-order n bits of the first address; a second comparison circuit that outputs the result of comparison of the higher-order n bits of the second start address memorized in the start address memory circuit with the higher-order n bits of the first address; and a second selecting circuit that, based on the result of comparison output from the first and second comparison circuits, outputs the address that is equal to or greater than the first start address and smaller than the second start address out of the first and second addresses to the first address bus and the other address out of the first and second addresses to the second address bus.

In order to achieve the above object, according to another aspect of the present invention there is provided a bus address selecting method of selecting addresses to be output to a first address bus connected to a first memory and a second address bus connected to a second memory, the method comprising outputting first and second addresses stored in first and second address registers out of a plurality of address registers, based on a selecting bit composed of a predetermined plurality of bits in an instruction code; and outputting the first address to one of the first and second address buses and the second address to the other of the first and second address buses, based on predetermined higher-order n bits of at least one of the first and second addresses.

Other features of the present invention will appear from accompanying drawings and the description of this specification.

### BRIEF DESCRIPTION OF THE DRAWINGS

For more thorough understanding of the present invention and advantages thereof, reference should be made to the following description taken in connection with accompanying drawings, in which:

FIG. 1 depicts an example of circuit configuration of a DSP comprising a bus address selecting circuit that is one of embodiments of the present invention;

FIG. 2 depicts an example of configuration of an instruction code;

FIG. 3 depicts an example of relationship between an address register selecting bit and combinations of address registers;

FIG. 4 depicts an example of address space;

FIG. 5 depicts an example of information stored in a mode register;

FIG. 6 depicts an example of parallel processing;

FIG. 7 depicts a general example of configuration of a DSP having two memories;

FIG. 8 depicts a general example of an instruction code;

FIG. 9 depicts an example of relationship between an address register selecting bit and combinations of address registers; and

FIG. 10 depicts an example of parallel processing.

### DETAILED DESCRIPTION OF THE INVENTION

At least the following matters will become apparent from the description of this specification and the accompanying drawings.

==Circuit Configuration==

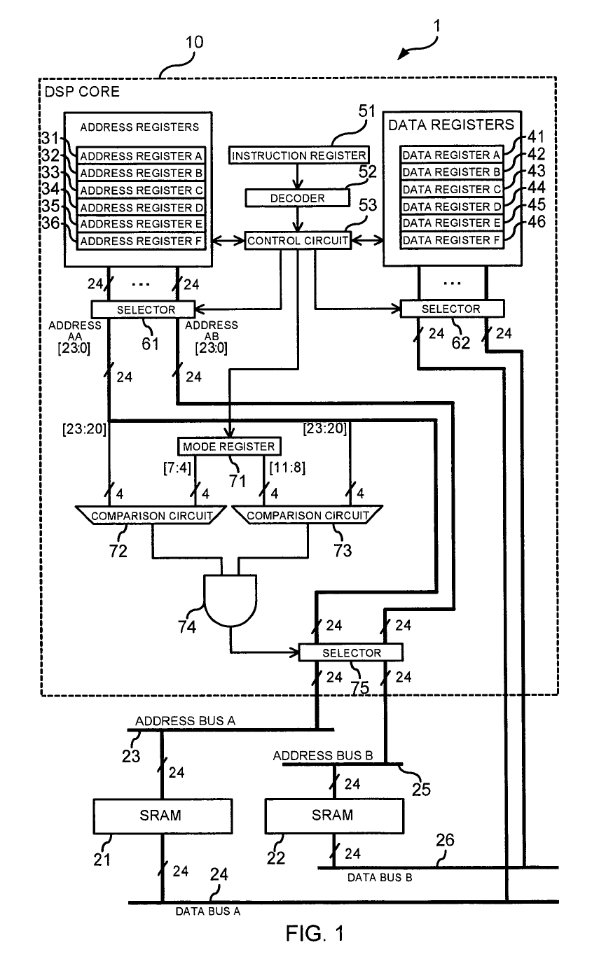

FIG. 1 depicts an example of a circuit configuration of a Digital Signal Processor (DSP) comprising a bus address selecting circuit that is one of embodiments of the present invention. The DSP 1 is a processor that executes data processing of various kinds of digital signals such as decoding processing of a digital audio signal. The DSP 1 comprises a DSP core 10 and, for example, two Static Random Access Memories (SRAMs) 21 and 22 (first and second memories). While the memories included in the DSP 1 are SRAMs 21 and 22 in the present embodiments, the kind of memory to be included in the DSP 1 is not limited to the SRAM, but any memory that is data-readable and -recordable is acceptable such as a Dynamic Random Access Memory (DRAM) and a Flash Memory.

The DSP core 10 is a circuit that executes various kinds of data processing by sequentially reading out a program (instruction codes) stored in a Read Only Memory (ROM) not shown, etc. SRAMs 21 and 22 store various kinds of data to be read or written by the DSP core 10. The SRAM 21 is connected, for example, to a 24-bit address bus A 23 (first address bus) and, at the address specified by way of the address bus A 23, the data is read or written by way of, for example, a 24-bit data bus A 24. The SRAM 22 is connected, for example, to a 24-bit address bus B 25 (second address bus) and, at the address specified by way of the address bus B 25, the data is read or written by way of, for example, a 24-bit data bus B 26. It may be so configured that the SRAMs 21 and 22 can exchange data, for example, with a mass-storage Synchronous DRAM (SDRAM) provided external to the DSP 1, as required.

Detailed description will be made of internal configuration of the DSP core 10. The DSP core 10 comprises, for example, 6 address registers 31 to 36, for example, 6 data registers 41 to 46, an instruction register 51, a decoder 52, a control circuit 53, a selector 61 for selecting the address registers, a selector 62 for selecting the data registers, a mode register 71 (start address memory circuit), comparison circuits 72 and 73, an AND circuit 74, and a selector 75 for selecting the address buses.

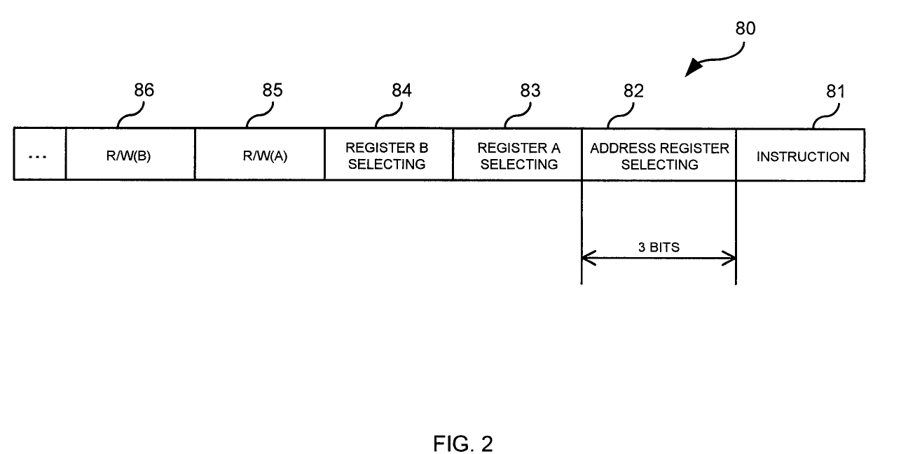

The address registers 31 to 36 store, for example, 24-bit addresses for accessing the SRAMs 21 and 22, etc. The data registers 41 to 46 store the data read out from the SRAMs 21 and 22, etc., or the data to be written to the SRAMs 21 and 22, etc. The instruction register 51 stores the instruction code read out from the ROM not shown, etc. FIG. 2 depicts an example of configuration of the instruction code. The instruction code 80 comprises an instruction bit 81, an address register selecting bit 82 (selecting bit), a register A selecting bit 83, a register B selecting bit 84, Read/Write selecting bits 85 and 86, etc.

The instruction bit 81 stores a code indicating the kind of instruction. The address register selecting bit 82 is the information for selecting two address registers (first and second address registers) to be output to the address buses 23 and 25 out of the address registers 31 to 36 and is composed of, for example, three bits. The register A selecting bit 83 is the information for selecting the data register in which to store the data read out from the SRAM 21 or the data to be written to the SRAM 21, out of the data registers 41 to 46. The register B selecting bit 84 is the information for selecting the data register in which to store the data read out from the SRAM 22 or the data to be written to the SRAM 22, out of the data registers 41 to 46. The Read/Write selecting bit (R/W (A) bit) 85 is the information for specifying whether to read out the data from the SRAM 21 or to write the data to the SRAM 21. The Read/Write selecting bit (R/W (B) bit) 86 is the information for specifying whether to read out the data from the SRAM 22 or to write the data to the SRAM 22.

In addition to the above, the instruction code 80, in some cases, includes, for example, the information for selecting addressing mode such as outputting to the address buses 23 and 25 the addresses obtained by adding the address stored in an offset register (not shown) to the addresses stored in the address registers 31 to 36.

The decoder 52 decodes the instruction code 80 stored in the instruction register 51 and transmits the result to the control circuit 53. The control circuit 53, based on the result of decoding transmitted by the decoder 52, carries out outputting of the signal for selecting the address registers 31 to 36 and the data registers 41 to 46, execution of various instructions, etc.

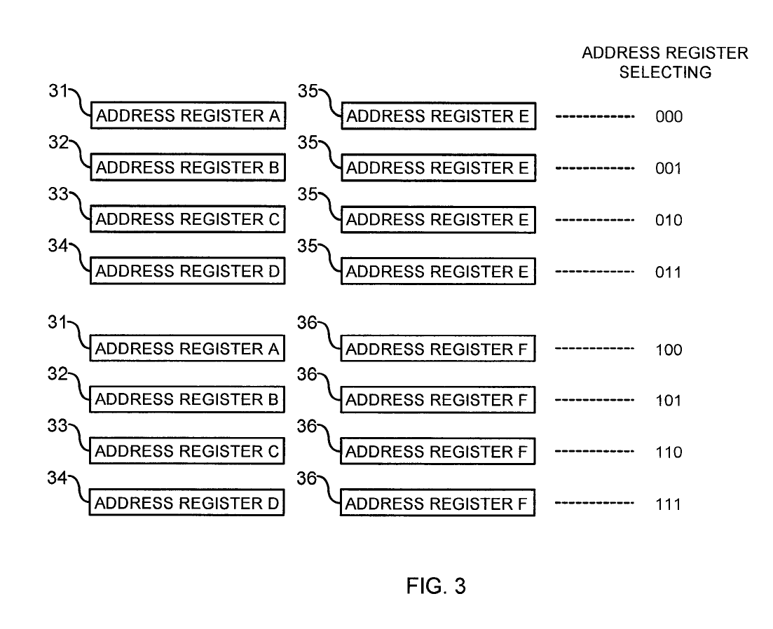

FIG. 3 depicts an example of relationship between the address register selecting bit 82 and combinations of address registers. As shown in the diagram, when, for example, contents of the address register selecting bit 82 are “000”, the address register A 31 and the address register E 35 are selected. Namely, in this case, the selecting signal for selecting the address register A 31 and the address register E 35 is output by the control circuit 53 (selecting signal output circuit) to the selector 61 (first selecting circuit).

For example, when the address register selecting bit 82 is “001”, the selecting signal is output for selecting the address register B 32 and the address register E 35; when the address register selecting bit 82 is “010”, the selecting signal is output for selecting the address register C 33 and the address register E 35; and when the address register selecting bit 82 is “011”, the selecting signal is output for selecting the address register D 34 and the address register E 35.

For example, when the address register selecting bit 82 is “100”, the selecting signal is output for selecting the address register A 31 and the address register F 36; when the address register selecting bit 82 is “101”, the selecting signal is output for selecting the address register B 32 and the address register F 36; when the address register selecting bit 82 is “110”, the selecting signal is output for selecting the address register C 33 and the address register F 36; and when the address register selecting bit 82 is “111”, the selecting signal is output for selecting the address register D 34 and the address register F 36.

In the present embodiments, the address register selecting bit 82 is set according to the description in the program. For example, if the address stored in the address register n (n=A to F) 31 to 36 is expressed as “an” and the data to be stored in the data register n (n=A to F) 41 to 46 is expressed as “m” and the program has a description of “ra=[aa++], rb=[ae++];”, then the combination of the address registers is the address register A 31 and the address register E 35, and “000” is set at the address register selecting bit 82. Likewise, for example, if the program has a description of “ra=[ab++], rb=[ae++];”, then the combination of the address registers is the address register B 32 and the address register E 35, and “001” is set at the address register selecting bit 82.

A 24-bit address being output from each of the address registers 31 to 36 is being input to the selector 61. The selector 61, based on the selecting signal input from the control circuit 53, outputs an address AA (first address) and an address AB (second address) output from two address registers out of the address registers 31 to 36.

The selector 62, when reading out the data from the SRAMs 21 and 22, outputs the data on the data bus A 24 and the data bus B 26 to two data registers out of the data registers 41 to 46, based on the selecting signal input from the control circuit 53. When writing the data to the SRAMs 21 and 22, the selector 62, based on the selecting signal input from the control circuit 53, output the data output from two data registers out of the data registers 41 to 46 to the data bus A 24 and the data bus B 26.

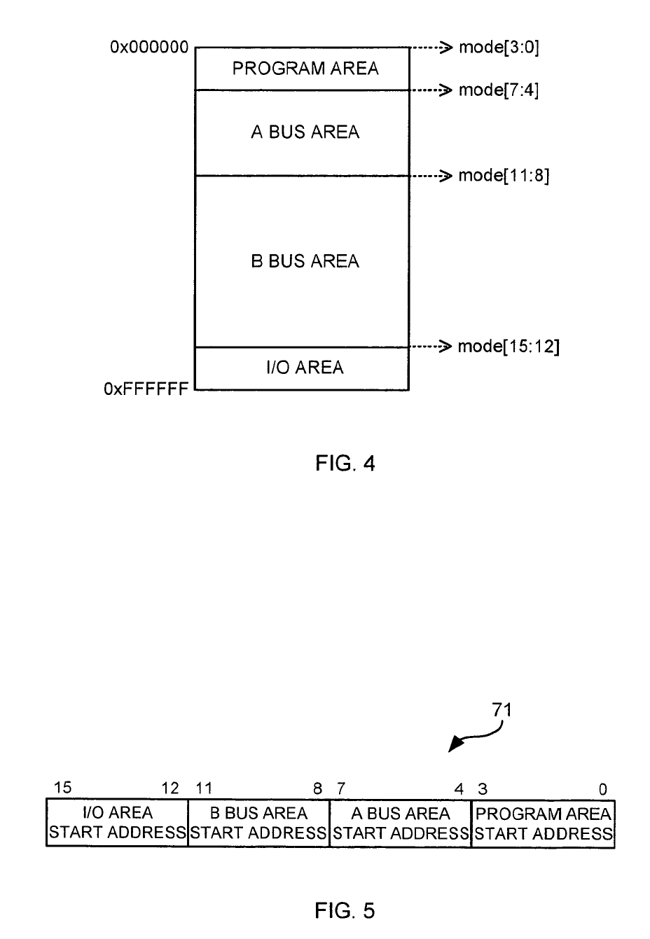

A mode register 71 stores a start address of each of divided areas in the address space. FIG. 4 depicts an example of the address space. FIG. 5 depicts an example of the information stored in the mode register 71. The address space of, for example, 24 bits shown in FIG. 4 is composed of a program area, an A bus area (data area of SRAM 21), a B bus area (data area of SRAM 22), and an I/O area, and the start address of each area is at the head of a division of, for example, one megabyte. When the start address of each area is at the head of a division of one megabyte, to which area an address belongs can be determined by higher-order four bits (predetermined higher-order n bits) of the address.

Accordingly, in the present embodiments, the higher-order four bits of the start address of each area are set at the mode register 71, as shown in FIG. 5. Specifically, the higher-order four bits of the start address of the program area are set at 0th bit to 3rd bit, the higher-order four bits of the start address of the A bus area are set at 4th bit to 7th bit, the higher-order four bits of the start address of the B bus area are set at 8th bit to 11th bit, and the higher-order four bits of the start address of the I/O area are set at 12th bit to 15th bit. Contents of the mode register 71 can be rewritten in accordance with a change of the address space.

The comparison circuit 72 outputs the result of comparison indicative of whether or not the address AA is equal to or greater than the start address of the A bus area. Specifically, the comparison circuit 72 compares the higher-order four bits [23:20] of the address AA [23:0] output from the selector 61 and the higher-order four bits of the start address of the A bus area stored at 4th bit to 7th bit [7:4] of the mode register 71 and outputs, for example, “1” if the higher-order four bits of the address AA is equal to or greater than the higher-order four bits of the A bus area and outputs, for example, “0” if the higher-order four bits of the address AA is smaller than the higher-order four bits of the A bus area.

The comparison circuit 73 outputs the result of comparison indicative of whether the address AA is smaller than the start address of the B bus area. Specifically, the comparison circuit 73 compares the higher-order four bits [23:20] of the address AA [23:0] output from the selector 61 and the higher-order four bits of the start address of the B bus area stored at 8th bit to 11th bit [11:8] of the mode register 71 and outputs, for example, “1” if the higher-order four bits of the address AA is smaller than the higher-order four bits of the B bus area and outputs, for example, “0” if the higher-order four bits of the address AA is equal to or greater than the higher-order four bits of the B bus area.

The AND circuit 74 outputs a logical product of the comparison results output from the comparison circuits 72 and 73. Namely, if it is so arranged that “1” is output from the comparison circuit 72 when the address AA is equal to or greater than the start address of the A bus area and “1” is output from the comparison circuit 73 when the address AA is smaller than the start address of the B bus area, then “1” is output from the AND circuit 74 when the address AA is within the range of the A bus area.

The selector 75 outputs either one of the addresses AA and AB to the address bus A 23 and the other to the address bus B 25, depending on the output of the AND circuit 74. Specifically, if it is so arranged that “1” is output from the AND circuit 74 when the address AA is within the range of the A bus area, then the selector 75 outputs the address AA to the address bus A 23 and the address AB to the address bus B 25 when the output of the AND circuit is “1” and outputs the address AA to the address bus B 25 and the address AB to the address bus A 23 when the output of the AND circuit is “0”.

The control circuit 53, the selector 61, the mode register 71, the comparison circuits 72 and 73, the AND circuit 74 and the selector 75 correspond to an example of a bus address selecting circuit of the present invention. Furthermore, the control circuit 53 and the selector 61 correspond to an example of an address output circuit of the present invention and the mode register 71, the comparison circuits 72 and 73, the AND circuit 74 and the selector 75 correspond to an example of a bus selecting circuit of the present invention.

==Description of Operation==

Description will then be made of the operation of selecting the addresses to be output to the address bus A 23 and the address bus B 25 in the DSP 1. Firstly, description will be made of the case, as an example, of executing “ra=[aa++], rb=[ae++];” that is a program to read out the data from the SRAMs 21 and 22. In this case, since the order of description of address registers in the program is the address register A 31 followed by the address register E 35, “000” is set at the address register selecting bit 82 in the instruction code 80. The information for selecting the data register A 41 is set at the register A selecting bit 83 and the information for selecting the data register B 42 is set at the register B selecting bit 84. The information indicating the reading out of the data is set at the R/W(A) bit 85 and the R/W(B) bit 86.

The decoder 52 decodes the instruction code 80 in which above information is set and transmits thus decoded information to the control circuit 53. The control circuit 53, based on the information from the decoder 52, transmits the selecting signal for selecting the address register A 31 and the address register E 35 to the selector 61. The selector 61, based on the selecting signal from the control circuit 53, outputs the address stored at the address register A 31 as the address AA and the address stored at the address register E 35 as the address AB.

The comparison circuit 72 outputs the result of comparison of the higher-order four bits of the address AA and the higher-order four bits of the start address of the A bus area set at the mode register 71. The comparison circuit 73 outputs the result of comparison of the higher-order four bits of the address AA and the higher-order four bits of the start address of the B bus area set at the mode register 71. The AND circuit 74 outputs a logic product of the outputs of the comparison circuits 72 and 73. In the present embodiments, “1” is output from the AND circuit 74 when the address stored at the address register A 31 is within the range of the A bus area and “0” is output from the AND circuit 74 when the address stored at the address register A 31 is outside the range of the A bus area.

The selector 75, based on the output signal from the AND circuit 74, outputs the address AA to the address bus A 23 and the address AB to the address bus B 25 when the address stored at the address register A 31 is within the range of the A bus area. Contrarily, the selector 75 outputs the address AA to the address bus B 25 and the address AB to the address bus A 23 when the address stored at the address register A 31 is outside the range of the A bus area. Thereafter, the data stored at the specified addresses of the SRAMs 21 and 22 is output to the data bus A 24 and the data bus B 26. The selector 62, based on the information from the control circuit 53, output the data on the data bus A 24 to the data register A 41 and the data on the data bus B 26 to the data register B 42.

In the DSP 1, the same processing is also performed in the case of writing the data to the SRAMs 21 and 22. In the case of writing the data as well, the addresses to be output to the address bus A 23 and the address bus B 25 are selected based on the address AA and the address AB to be output from the selector 61. Then, the data stored at the data register specified by the register selecting A bit 83 in the instruction code 80 is output to the data bus A 24 by way of the selector 62 and the data is written to the SRAM 21. Also, the data stored at the data register specified by the register selecting B bit 84 in the instruction code 80 is output to the data bus B 26 by way of the selector 62 and the data is written to the SRAM 22.

As seen above, in the DSP 1, irrespective of the order of description of the address registers in the program, the addresses set in the address registers are judged by the hardware and, based on the result of the judgement, the addresses to be output to the address bus A 23 and the address bus B 25, respectively, are selected. Namely, without increasing the number of bits for the instruction code 80, the flexibility can be improved in selecting the addresses to be output to the address bus A 23 and the address bus B 25.

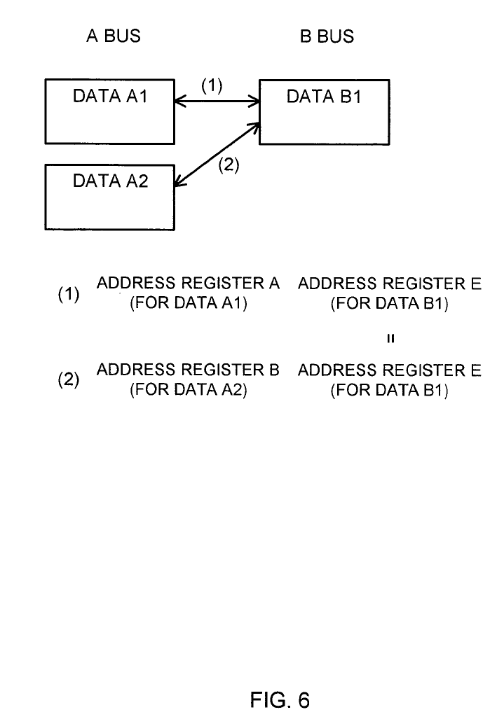

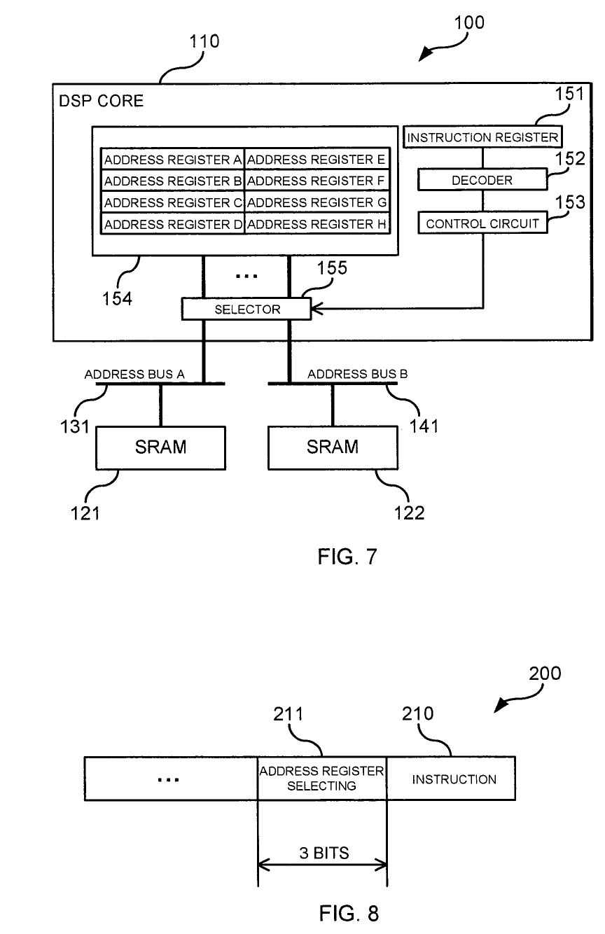

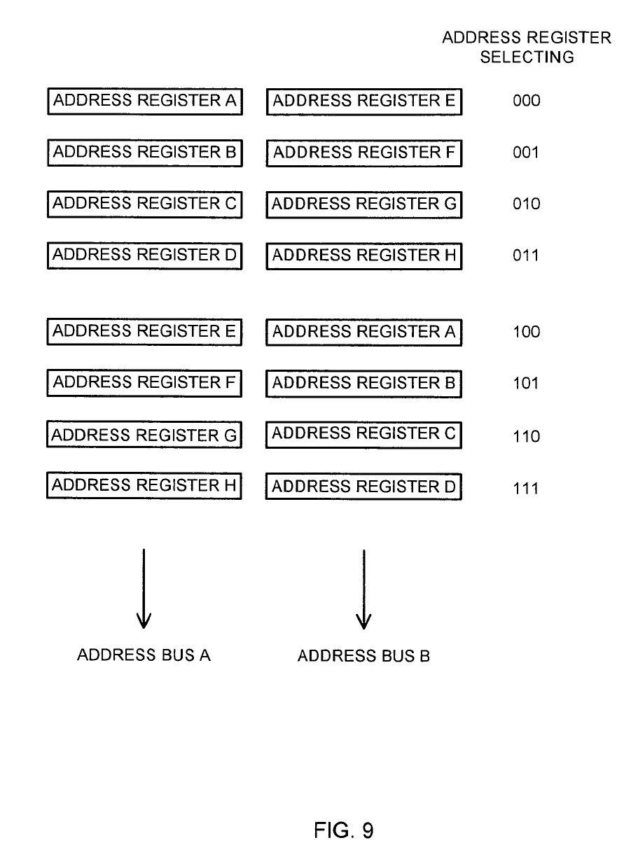

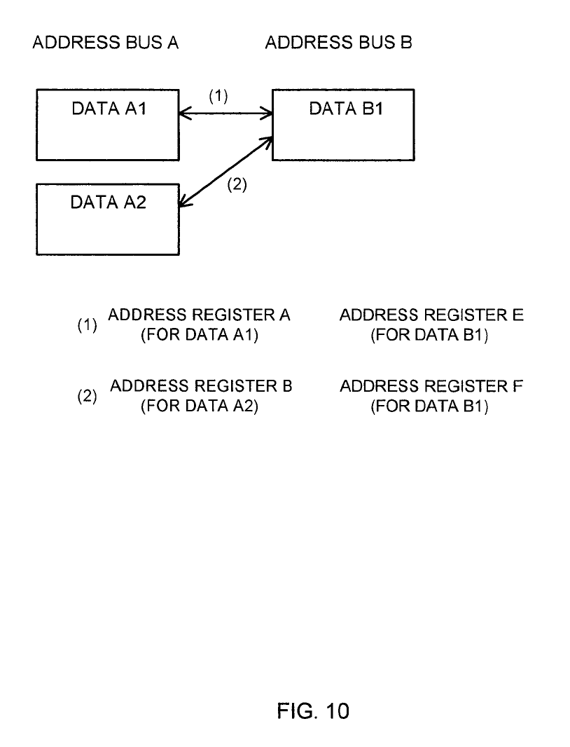

Description will then be made of the case of executing a parallel processing in the DSP 1. FIG. 6 depicts an example of the parallel processing. In this example, the processing (1) uses the data A1 stored in the SRAM 21 and the data B1 stored in the SRAM 22. The processing (2) uses the data A2 stored in SRAM 21 and the data B1 stored in the SRAM 22.

To execute the processing (1), the data A1 and the data B1 must be read out, and the program for such purpose is described, for example, as “ra=[aa++], rb=[ae++];”. Also, to execute the processing (2), the data A2 and the data B1 must be read out, and the program for such purpose is described, for example, as “rc=[ab++], rd=[ae++];”. It is assumed that prior to the execution of these programs, the address at which the data A1 is stored is set at the address register A 31 (first address register), the address at which the data A2 is stored is set at the address register B 32 (third address register), and the address at which the data B1 is stored is set at the address register E 35 (second address register).

When the program is described as above, “000” (first value) is set at the address register selecting bit 82 in the instruction code 80 for reading out the data A1 and the data B1, and “001” (second value) is set at the address register selecting bit 82 in the instruction code 80 for reading out the data A2 and data B1. In the execution of the processing (1), by the operation of the control circuit 53 and the selector 61, the address stored at the address register A 31 is output as the address AA and the address stored at the address register E 35 is output as the address AB. Then, the data A1 is read out from the SRAM 21 to the data register A 41 and the data B1 is read out from the SRAM 22 to the data register B 42. In the execution of the processing (2), by the operation of the control circuit 53 and the selector 61, the address stored at the address register B 32 is output as the address AA and the address stored at the address register E 35 is output as the address AB. Then, the data A2 is read out from the SRAM 21 to the data register C 43 and the data B1 is read out from the SRAM 22 to the data register D 44.

In this example, the address register E 35 is used in both of the processing (1) and the processing (2), as the address register for reading out the data B1. Namely, it is not necessary to use separate address registers for reading out the data B1 in the processing (1) and the processing (2) and an increase in the number of cycles caused by setting the same address in different address registers can be avoided.

Description has been made of the DSP 1 of the present embodiments. As described above, in the DSP 1, irrespective of the order of description of the address registers in the program, the addresses to be output to the address bus A 23 and the address bus B 25, respectively, are selected by judging the addresses stored in the address registers by means of a circuit. Namely, without increasing the number of bits for the instruction code 80, the flexibility in the bus address selection can be improved.

Also, in the DSP 1, the address register that can be used as a pair to the address register E 35 or the address register F 36 is not fixed to one. Therefore, an increase in the number of cycles can be avoided, for example, when the same address is referenced in the processing executed in parallel. Namely, the flexibility in selecting the addresses to be output to the address bus A 23 and the address bus B 25 can be improved without increasing the number of bits for the instruction code 80.

Also, in the DSP 1, a change of the address space can be flexibly dealt with by rewriting the information stored at the mode register 71.

While The DSP 1 confirms whether the address AA is within the range of the A bus area by comparing the higher-order four bits of the address AA with the higher-order four bits of the start address of the A bus area and with the higher-order four bits of the start address of the B bus area, comparison may be made only with the higher-order four bits of the start address of the B bus area. Namely, it may be so arranged that if the higher-order four bits of the address AA is smaller than the higher-order four bits of the start address of the B bus area, the address AA is output to the address bus A 23 and the address AB is output to the address bus B 25. If it is so arranged that comparison is made only with the higher-order four bits of the start address of the B bus area, then the comparison circuit 72 and the AND circuit 74 become unnecessary and the scale of the circuit can be smaller.

However, as described in the present embodiments, it can securely be checked whether the address AA is within the range of the A bus area by using the comparison circuits 72 and 73 and the AND circuit 74.

Also, in the present embodiments, the address AB is not checked in terms of its value and is output to the address bus opposite to that of the address AA. By such configuration, the circuit for checking the value of the address AB becomes unnecessary and the circuit size can be made small. However, when it is necessary to accurately check the value of the address, it may be so arranged that, with respect to the address AB as well, comparison is made with the information stored in the mode register 71.

The above embodiments are intended for easy understanding of the present invention and are not to be interpreted to limit the present invention. Changes and improvements can be made to the present invention without departing from the intent thereof and the present invention includes equivalents thereof.

For example, while in the present embodiments, the address bus selection is made in the DSP, such selection can be made not only in the DPS but also in any processing circuit having a plurality of memories. While the present embodiments adopt the configuration of two pieces each of the memory and the address bus, the configuration can be extended to have three or more pieces each of the memory and the address bus.

What is claimed is:

1. A bus address selecting circuit that selects addresses to be output to a first address bus connected to a first memory and a second address bus connected to a second memory, comprising:
an address output circuit that, based on a selecting bit composed of a predetermined plurality of bits in an instruction code, outputs addresses stored in first and second address registers out of a plurality of address registers as first and second addresses; and
a bus selecting circuit that, based on predetermined higher-order n bits of at least one of the first and second addresses, outputs the first address to one of the first and second address buses and the second address to the other of the first and second address buses.

2. The bus address selecting circuit of claim 1, wherein
the address output circuit outputs the addresses stored in the first and second address registers out of the plurality of address registers as the first and second addresses when the selecting bit is of a first value and outputs the addresses stored in a third address register and the second address register out of the plurality of address registers as the first and second addresses when the selecting bit is of a second value.

3. The bus address selecting circuit of claim 1, wherein
the address output circuit comprises:
a selecting signal output circuit that, based on the selecting bit, outputs a selecting signal for selecting the first and second addresses; and
a first selecting circuit that, based on the selecting signal, selects and outputs the first and second addresses out of the addresses stored in the plurality of address registers.

4. The bus address selecting circuit of claim 2, wherein
the address output circuit comprises:
a selecting signal output circuit that, based on the selecting bit, outputs a selecting signal for selecting the first and second addresses; and
a first selecting circuit that, based on the selecting signal, selects and outputs the first and second addresses out of the addresses stored in the plurality of address registers.

5. The bus address selecting circuit of claim 1, wherein
the bus selecting circuit comprises a start address memory circuit that memorizes higher-order n bits of a start address of the second memory whose address in the address space is greater than that of the first memory, wherein
the bus selecting circuit, based on the higher-order n bits of the start address memorized in the start address memory circuit and the higher-order n bits of at least one of the first and second addresses, outputs the address smaller than the start address out of the first and second addresses to the first address bus and the other address out of the first and second addresses to the second address bus.

6. The bus address selecting circuit of claim 2, wherein
the bus selecting circuit comprises a start address memory circuit that memorizes higher-order n bits of a start address of the second memory whose address in the address space is greater than that of the first memory, wherein
the bus selecting circuit, based on the higher-order n bits of the start address memorized in the start address memory circuit and the higher-order n bits of at least one of the first and second addresses, outputs the address smaller than the start address out of the first and second addresses to the first address bus and the other address out of the first and second addresses to the second address bus.

7. The bus address selecting circuit of claim 3, wherein
the bus selecting circuit comprises a start address memory circuit that memorizes higher-order n bits of a start address of the second memory whose address in the address space is greater than that of the first memory, wherein
the bus selecting circuit, based on the higher-order n bits of the start address memorized in the start address memory circuit and the higher-order n bits of at least one of the first and second addresses, outputs the address smaller than the start address out of the first and second addresses to the first address bus and the other address out of the first and second addresses to the second address bus.

8. The bus address selecting circuit of claim 4, wherein
the bus selecting circuit comprises a start address memory circuit that memorizes higher-order n bits of a start address of the second memory whose address in the address space is greater than that of the first memory, wherein
the bus selecting circuit, based on the higher-order n bits of the start address memorized in the start address memory circuit and the higher-order n bits of at least one of the first and second addresses, outputs the address smaller than the start address out of the first and second addresses to the first address bus and the other address out of the first and second addresses to the second address bus.

9. The bus address selecting circuit of claim 5, wherein
the higher-order n bits of the start address memorized in the start address memory circuit are rewritable.

10. The bus address selecting circuit of claim 5, wherein
the bus selecting circuit comprises:
the start address memory circuit;
a comparison circuit that outputs the result of comparison of the higher-order n bits of the start address memorized in the start address memory circuit with the higher-order n bits of the first address; and
a second selecting circuit that, based on the result of comparison output from the comparison circuit, outputs the address smaller than the start address out of the first and second addresses to the first address bus and the other address out of the first and second addresses to the second address bus.

11. The bus address selecting circuit of claim 9, wherein
the bus selecting circuit comprises:
the start address memory circuit;
a comparison circuit that outputs the result of comparison of the higher-order n bits of the start address memorized in the start address memory circuit with the higher-order n bits of the first address; and
a second selecting circuit that, based on the result of comparison output from the comparison circuit, outputs the address smaller than the start address out of the first and second addresses to the first address bus and the other address out of the first and second addresses to the second address bus.

12. The bus address selecting circuit of claim 1, wherein
the bus selecting circuit comprises a start address memory circuit that memorizes higher-order n bits of first and second start addresses that are start addresses of the first and second memories, respectively, in the address space, wherein
the bus selecting circuit, based on the higher-order n bits of the first and second start addresses memorized in the start address memory circuit and the higher-order n bits of the first address, outputs the address that is equal to or greater than the first start address and smaller than the second start address out of the first and second addresses to the first address bus and the other address out of the first and second addresses to the second address bus.

13. The bus address selecting circuit of claim 2, wherein
the bus selecting circuit comprises a start address memory circuit that memorizes higher-order n bits of first and second start addresses that are start addresses of the first and second memories, respectively, in the address space, wherein
the bus selecting circuit, based on the higher-order n bits of the first and second start addresses memorized in the start address memory circuit and the higher-order n bits of the first address, outputs the address that is equal to or greater than the first start address and smaller than the second start address out of the first and second addresses to the first address bus and the other address out of the first and second addresses to the second address bus.

14. The bus address selecting circuit of claim 3, wherein
the bus selecting circuit comprises a start address memory circuit that memorizes higher-order n bits of first and second start addresses that are start addresses of the first and second memories, respectively, in the address space, wherein
the bus selecting circuit, based on the higher-order n bits of the first and second start addresses memorized in the start address memory circuit and the higher-order n bits of the first address, outputs the address that is equal to or greater than the first start address and smaller than the second start address out of the first and second addresses to the first address bus and the other address out of the first and second addresses to the second address bus.

15. The bus address selecting circuit of claim 4, wherein
the bus selecting circuit comprises a start address memory circuit that memorizes higher-order n bits of first and second start addresses that are start addresses of the first and second memories, respectively, in the address space, wherein
the bus selecting circuit, based on the higher-order n bits of the first and second start addresses memorized in the start address memory circuit and the higher-order n bits of the first address, outputs the address that is equal to or greater than the first start address and smaller than the second start address out of the first and second addresses to the first address bus and the other address out of the first and second addresses to the second address bus.

16. The bus address selecting circuit of claim 12, wherein
the higher-order n bits of the first and second start addresses memorized in the start address memory circuit are rewritable.

17. The bus address selecting circuit of claim 12, wherein
the bus selecting circuit comprises:
the start address memory circuit;
a first comparison circuit that outputs the result of comparison of the higher-order n bits of the first start address memorized in the start address memory circuit with the higher-order n bits of the first address;
a second comparison circuit that outputs the result of comparison of the higher-order n bits of the second start address memorized in the start address memory circuit with the higher-order n bits of the first address; and
a second selecting circuit that, based on the result of comparison output from the first and second comparison circuits, outputs the address that is equal to or greater than the first start address and smaller than the second start address out of the first and second addresses to the first address bus and the other address out of the first and second addresses to the second address bus.

18. The bus address selecting circuit of claim 16, wherein
the bus selecting circuit comprises:
the start address memory circuit;
a first comparison circuit that outputs the result of comparison of the higher-order n bits of the first start address memorized in the start address memory circuit with the higher-order n bits of the first address;
a second comparison circuit that outputs the result of comparison of the higher-order n bits of the second start address memorized in the start address memory circuit with the higher-order n bits of the first address; and
a second selecting circuit that, based on the result of comparison output from the first and second comparison circuits, outputs the address that is equal to or greater than the first start address and smaller than the second start address out of the first and second addresses to the first address bus and the other address out of the first and second addresses to the second address bus.

19. A bus address selecting method of selecting addresses to be output to a first address bus connected to a first memory and a second address bus connected to a second memory, the method comprising:
outputting first and second addresses stored in first and second address registers out of a plurality of address registers, based on a selecting bit composed of a predetermined plurality of bits in an instruction code; and
outputting the first address to one of the first and second address buses and the second address to the other of the first and second address buses, based on predetermined higher-order n bits of at least one of the first and second addresses.
